(19) United States
(12) Patent Application Publication
(10) Pub. No.: US 2026/0048424 A1
(43) Pub. Date: Feb. 19, 2026

(54) SYSTEM AND METHOD OF CLEARING CLOGS IN A PLUMBING ENVIRONMENT

(71) Applicant: Tim Koerner, Ronkonkoma, NY (US)

(72) Inventor: Tim Koerner, Ronkonkoma, NY (US)

(21) Appl. No.: 18/807,094

(22) Filed: Aug. 16, 2024

(51) Int. Cl. B08B 9/032; E03C 1/304

(52) U.S. Cl. CPC B08B 9/0325; E03C 1/304; B08B 2209/032

(57) ABSTRACT

The invention is a waste line monitoring system that detects developing blockages and provides automated responses including cleaning, testing, and data collection. The monitoring system includes sensors positioned to detect flow restrictions, processing unit with software to analyze conditions, and automated response capabilities. When blockages are detected, the system can activate cleaning through a manifold with hot water distribution to outlet lines connected to fixtures. The system also provides testing capabilities using air/water pressurization with pressure monitoring, and collects performance data including clog frequency, severity, and response times for building assessment and problem area identification.

### TECHNICAL FIELD

The presently disclosed subject matter relates generally to the field of cleaning and maintaining plumbing pipes and drains. For example, the disclosed system and method can include automated inline jetting systems that preventatively clean pipes and clear them of obstructions, such as clogs.

### BACKGROUND

Restaurants, coffee shops, pet grooming facilities, apartment complexes, and any other facility that includes drains commonly suffer plumbing backups caused by a clog. In some cases, a clogged drain prevents the use of sinks or drains that are necessary for the facility to operate. When this happens, the facility must stop operation and shut down while a plumber drives to the facility and works to clear the clog. Even when the clogged drains do not cause a complete shutdown, a clogged sink or drain may limit productivity, cause inconvenience, and impose a safety hazard until a plumber clears the clog. Whether the clog stops all operations or merely limits productivity, the facility must have a plumber dispatched to clear the clog.

To clear a clogged drain using conventional methods, a plumber often uses a portable jetting system. Specifically, a portable jetting system may include a water nozzle on the end of a long hose or other attachment. The plumber typically accesses the wastewater system through a drain or a clean-out port. The plumber will feed the hose through the drain until it reaches the clog. Once the hose reaches the clog, the plumber forces water through the nozzle at the head of the hose line. The water then breaks up the clog and flushes the debris through the drain system, thereby clearing the pipes.

However, high quality plumbing services are expensive. Some of the cost is due to the fact that skilled plumbers must own and maintain a large variety of tools and equipment so that they can quickly diagnose and fix any plumbing problem they may encounter. Further, the facility remains inconvenienced (e.g., water supply shut off) until the plumber can arrive and address the clogged drain.

It would therefore be beneficial to provide a system that can be used to easily and quickly remove clogs from the drains of a plumbing array. It would further be beneficial if the system can be used to prevent clogs by regularly clearing debris from sinks and drain lines before it builds up enough to cause a clog. Accordingly, the disclosed system can automatically and preventatively clear the pipes and drain lines of a wastewater system to substantially decrease the likelihood of debris building up in the system and causing a full-blown clog.

### SUMMARY

In some embodiments, the presently disclosed subject matter is directed to a plumbing drain clog removal system. Particularly, the system comprises a manifold comprising a hot water inlet line in fluid communication with a hot water source. The hot water inlet line provides a pathway (e.g., tubes or pipes) for hot water to travel from a hot water source to a desired location. The system includes a plurality of outlet lines operatively connected to the manifold, each outlet line in fluid connection to a dedicated fixture in an environment, wherein each outlet line comprises a valve configured to open or close flow of water through the outlet line. Each outlet line is coupled with a drain line of the dedicated fixture. Hot water from the hot water inlet line is configured to flow within the interior of the manifold and be selectively distributed to a desired outlet line. Each outlet line therefore includes a first end connected to the manifold and a second end connected to a drain line of a dedicated fixture, with a valve positioned along the length of the outlet line that controls flow of water from the manifold to the fixture drain line.

In some embodiments, the manifold is in fluid communication with an air chuck configured to increase pressure within an outlet line.

In some embodiments, the hot water line includes a valve that controls the flow of hot water into the manifold.

In some embodiments, the valve is a solenoid valve.

In some embodiments, the environment comprises a plurality of fixtures selected from at least one toilet, sink, bathtub, shower, washing machine, or combinations thereof.

In some embodiments, the environment is an apartment complex, industrial setting, or residential setting. An apartment complex is defined as a room or group of rooms among similar sets in one building, designed for use as a dwelling. An industrial setting includes manufacturing or retail buildings that typically include several offices or other structures under a single roof. A residential setting refers to a single house or other structure.

In some embodiments, the valves are independently operated. Stated another way, one or more valves can be activated to an “on” position, allowing the flow of water through the line while one or more other valves are not activated and remain in a “closed” position where water cannot flow through the line. Thus, each valve can be actuated to an on (or off) position regardless of what the remainder of the valves are doing.

In some embodiments, the valves are remotely operated (e.g., wirelessly through an operator's phone, computer, laptop, etc.).

In some embodiments, the presently disclosed subject matter is directed to a method of removing a clog from a fixture drain line in an environment comprising a plurality of fixtures. Specifically, the method comprises activating the valve of an outlet line of the disclosed system to an open position, allowing the flow of hot water from the manifold through the outlet line to the drain line of a fixture comprising a clog in the associated drain line. Hot water travels from the hot water source, through the hot water line into the manifold, through the open valve to the outlet line and to the drain line of the fixture comprising a clog to dislodge the clog from the drain line.

In some embodiments, the method includes activating a valve positioned on the hot water line to an open position, allowing the flow of hot water into the manifold prior to activating the valve of the outlet line.

In some embodiments, the valve of the outlet line in communication with the clogged drain line is activated to a closed position blocking the flow of hot water from the manifold through the outlet to the outlet line after the clog has been dislodged.

In some embodiments, the method includes activating an air chuck in fluid communication with the manifold to supply a pressurized flow of hot water.

### BRIEF DESCRIPTION OF THE DRAWINGS

FIG. 1 is a cross-sectional view of a plumbing array in a conventional apartment complex in some embodiments of the presently disclosed subject matter.

FIG. 2 is a cross-sectional view of a clog removal system in use with a plumbing array in some embodiments of the presently disclosed subject matter.

FIG. 3a is a front plan view of a manifold comprising a plurality of outlet lines and a water line in communication with a water source in some embodiments of the presently disclosed subject matter.

FIGS. 3b and 3c illustrate an outlet line comprising a pressure sensor in accordance with some embodiments of the presently disclosed subject matter.

FIG. 3d is a front plan view of a manifold comprising a timer in accordance with some embodiments of the presently disclosed subject matter.

FIG. 4 is a front plan view of a single outlet line in fluid communication with a manifold and a fixture drain line in some embodiments of the presently disclosed subject matter.

FIG. 5a is a cross-sectional view of a clog positioned in a drain line of a fixture in some embodiments of the presently disclosed subject matter.

FIG. 5b is a cross-sectional view of a system manifold and outlet line in fluid communication with the drain line of FIG. 5a in some embodiments of the presently disclosed subject matter.

FIG. 5c is a cross-sectional view of the drain line of FIG. 5b with the clog removed in some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The presently disclosed subject matter is generally directed to a system and method of clearing drain lines of a plumbing array. The term “plumbing array” refers to a network that transports wastewater from a first location (e.g., residence or business) to an appropriate wastewater handling system. Plumbing arrays generally include a hot water supply line (including hot line manual shutoff valve) that delivers hot water, a cold water supply line (including a cold line manual shutoff valve) that delivers cold water, and an element for mixing hot water and cold water such as, for example, a mixing valve. Plumbing systems may include a water delivery device such as a shower, tub, sink, toilet, etc. The array further includes the associated drain lines that transport water to and from a plumbing fixture.

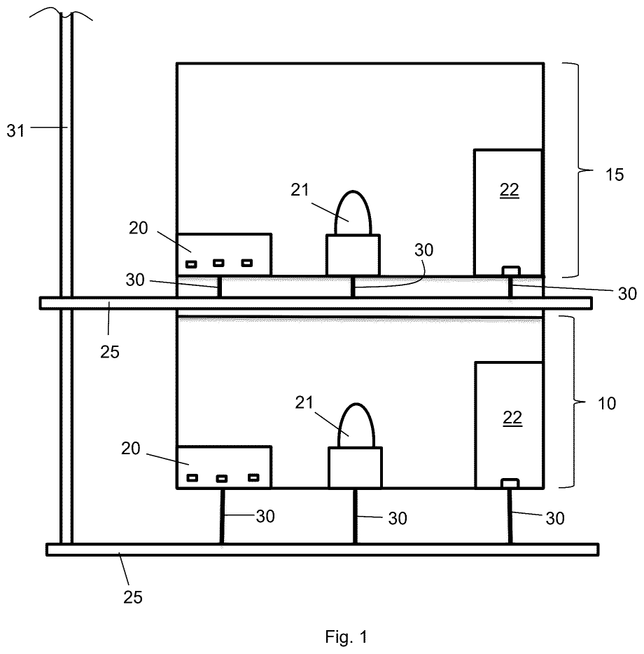

A typical drain system commonly used in building structures such as, for example, residential housing, apartment complexes, commercial/industrial buildings and the like is a gravity system. A gravity system relies on gravity to move wastewater from a plumbing device, such as a sink, through drainpipes and into a sewer system. FIG. 1 illustrates one embodiment of an apartment or industrial setting that includes a plumbing array. As shown, the environment includes first floor 10 and second floor 15 positioned above the first floor. It should be appreciated that the environment is not limited and can include a single floor or more than 2 floors. The setting includes several plumbing fixtures, such as sink 20, toilet 21, and bathtub/shower 22. Thet term “plumbing fixture” or “fixture” includes any appliance that transports wastewater, such as a toilet, sink, vanity, bathtub, shower, dishwasher, washing machine, and the like.

Each fixture is in fluid communication with sewer line 25 via one or more drain lines 30. The term “sewer line” refers to a conduit that transports wastewater from toilets, sinks, and other plumbing fixtures to a wastewater handling system or septic tank. The drain line is typically a vertically arranged pipe (although any arrangement of the drain line can be used) that connects to the outlet of a sink, tub, or other plumbing fixture at one end and the sewer line at the other end. Thus, the term “drain line” refers to a smaller pipe or set of pipes that connect individual plumbing fixtures (such as sinks, bathtubs, toilets, and showers) to the main sewer line or septic tank. A drain line therefore carries wastewater from a dedicated fixture to the main sewer line. Specifically, each fixture includes its own designed drain line, providing a fluid connection for water to flow from the fixture to sewer line 25.

In some embodiments, waste riser line 31 provides a conduit between floors (e.g., between first and second floors) allowing wastewater from a sewer line on each floor to be routed from the home or business.

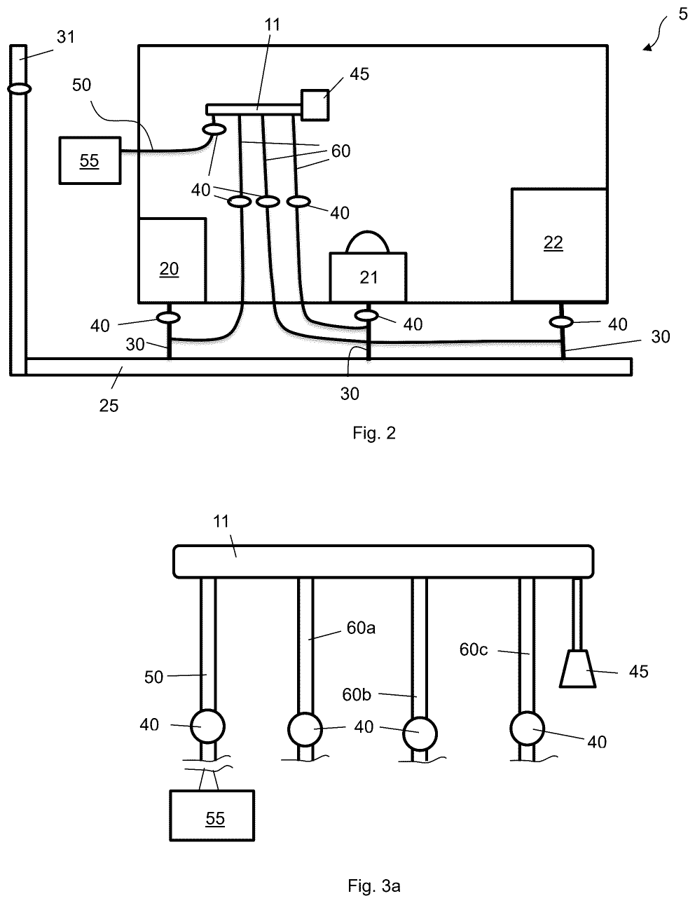

FIG. 2 illustrates the disclosed system 5 positioned in an environment. As illustrated, the system includes manifold 11. The term “manifold” can refer to a collection of one or more fluid pathways that are formed within a single unit or subassembly. The manifold functions to distribute water downstream to the control valve assemblies as needed. Thus, the manifold can be configured as a chamber having several outlets through which a liquid (e.g., hot water) is distributed. As shown, the manifold includes hot water feed 50 that inputs a volume of hot water into the system manifold from water source 55. The hot water feed can therefore be configured as a hose or pipe with a first end attached to a water source and an opposed second end attached to the manifold. In this way, water is routed from the water source to the manifold via water feed 50.

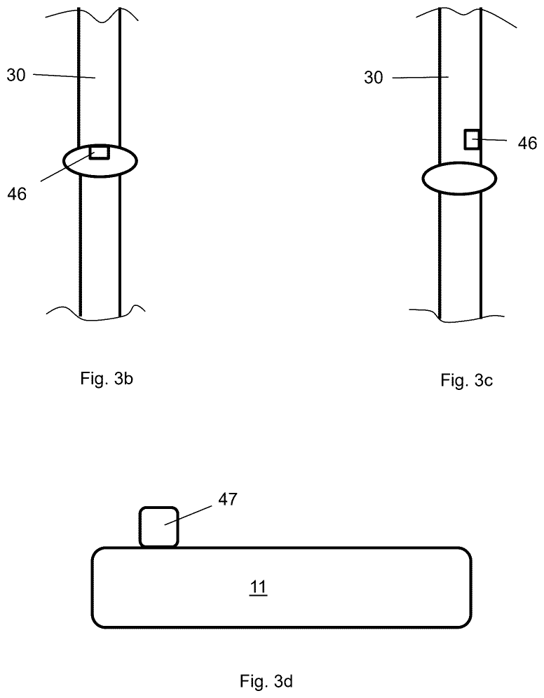

The manifold also includes a plurality of outlet lines 60 that each are in fluid connection with a single fixture. For example, the hot water can flow to first, second, or third outlets 60a, 60b, or 60c that route to (in one example) a sink, a toilet, and a shower, respectively, as illustrated in FIG. 3a. In this way, hot water is fed from hot water source 55, through the hot water feed via an outlet line to a desired appliance to unclog a corresponding drain line. It should be appreciated that the manifold can include any number of outlet lines 60, such as 1-10 or more. In some embodiments, the number of outlet lines corresponds to the number of plumbing fixtures in an environment.

Each outlet 60 of the manifold and the hot water feed includes valve 40 that independently controls the opening and closing of that outlet, thereby starting, slowing, or stopping the flow of hot water to a corresponding fixture. Thus, the system manually or automatically controls water flow. For example, the illustrated manifold of FIG. 3 distributes water to three output valves 60a, 60b, and 60c, each output valve associated with a different fixture in an environment. The term “valve” therefore refers to a device by which the flow of liquid, gas, or loose material may be started, stopped, or regulated, e.g., by a movable part that opens, shuts or partially obstructs one or more ports (e.g., inlet or outlet) or passageways.

Each outlet line is configured as a rigid or flexible pipe, hose, or other element with an open first and second end and a hollow, tubular interior. Each outlet line can have any suitable length (e.g., the straight line distance from a first end to an opposed second end) of about 1-50 feet or more (e.g., at least/no more than about 1, 5, 10, 15, 20, 25, 30, 35, 40, 45, or 50 feet). The first end of each outlet line is coupled with manifold 11. The second end of each outlet line is coupled with the drain line of a fixture (one outlet line per fixture).

Outlet lines 60 and the hot water feed line can be constructed from any suitable material such as (but not limited to) metal (e.g., stainless steel, copper), plastic, and the like.

Valve 40 can include any type of valve, such as a solenoid valve. The term “solenoid valve” refers to an electrically activated valve, typically used to control the flow or direction of air or liquid in fluid power systems. However, valve 40 is not limited and any type of valve can be used, such as a gate valve, pinch valve, piston valve, check valve, diaphragm valve, poppet valve, plug valve, ball valve, butterfly valve, globe valve, and the like. Thus, any type of valve that controls and regulates the flow of fluid in a system by closing, opening, or partially cutting off the flow of a fluid can be used.

Valves 40 can be controlled wirelessly, such as through an operator's phone or computer. In this way, system 5 can be remotely operated. In other embodiments, each valve can be wired and/or manually controlled.

In some embodiments, system 5 can include a sensor (e.g., a pressure sensor). The term “sensor” refers to any element that can detect a characteristic. For example, a pressure sensor includes a device for measuring the pressure or operating pressure of a gas or fluid in a vessel or container. A pressure sensor includes, for example, a sensor such as a piezoresistive strain gauge, a capacitive pressure sensor, an electromagnetic pressure sensor, or other commercially available pressure sensors. Specifically, pressure sensor 46 can be positioned or configured as part of valve 40 or upstream of the valve, as illustrated in FIGS. 3b and 3c, respectively. The sensor can detect an increase in pressure within a drain line or outlet line (the increase in pressure being an indicator that a full or partial clog is present within the line). In response, an operator can manually or remotely flush that particular drain line to remove the clog, as described below.

Alternatively or in addition, the system can be automated such that when a sensor detects the presence of a clog in a particular line (e.g., through sensor 46), the system automatically closes off the remainder of the drain lines, opens the corresponding valve, and passes a volume of hot water or air though the clogged line to flush out the clog. In this way, the system is automated and involves no operator input. Once the clog is removed, the corresponding valve is closed and the system reverts to an operating mode where the drain lines are open and functional.

The manifold can optionally include air chuck 45. The term “air chuck” refers to any element that can provide an input of pressure via water or air. In the disclosed system, the air chuck advantageously can be used to increase pressure within a particular outlet line to help free a clog. The air chuck and/or manifold can include a gauge (e.g., pressure gauge) allowing a user to add a desired amount of water or air to the system. The system can also include a relay that acts as the brain of the disclosed system in automated embodiments. The relay can be in communication with each valve of the system, allowing the valve to be opened and closed when appropriate (e.g., when flushing a drain line). A relay is an electrically operated switch that includes a set of input terminals for single or multiple control signals and a set of operating contact terminals. The relays can be useful where it is desired to control a circuit by an independent low-power signal, or where several circuits are controlled by one signal.

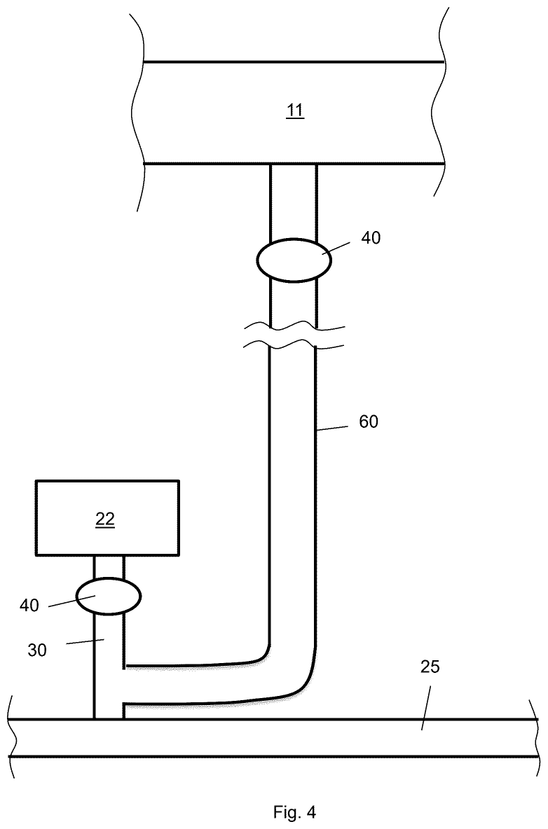

As shown, each of the outlet lines 60 is coupled to a corresponding fixture drain line (one outlet line per appliance drain line) using standard techniques, as shown in FIG. 4. For example, an adapter may be used. Thus, a single outlet line provides fluid communication between manifold 11 (and thus the flow of hot water) to a single fixture drain line 30 (e.g., a toilet drain line, bathtub drain line, or sink drain line, etc.). The system therefore is configured such that each outlet line is dedicated to a single fixture. In this way, a clog located within a particular drain line (e.g., the bathtub drain line) can be isolated and the clog cleared easily and quickly.

In use, system 5 can easily and effectively remove a clog from a plumbing array. The term “clog” broadly refers to any hinderance within a pipe or other conduit. For example, the clog can fully or partially prevent the flow of water within a drain line. Clogs can result from any of a variety of items present within the interior of a drain line, such as (but not limited to) an accumulation of hair, grease, paper products (e.g., paper towels, wet wipes), tampons, food scraps, mineral buildup, toilet paper, soap scum, etc.

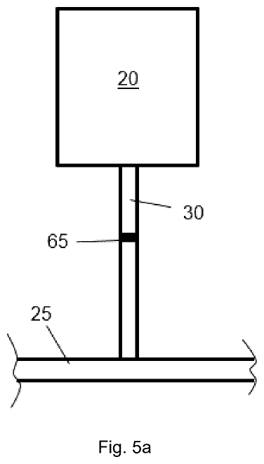

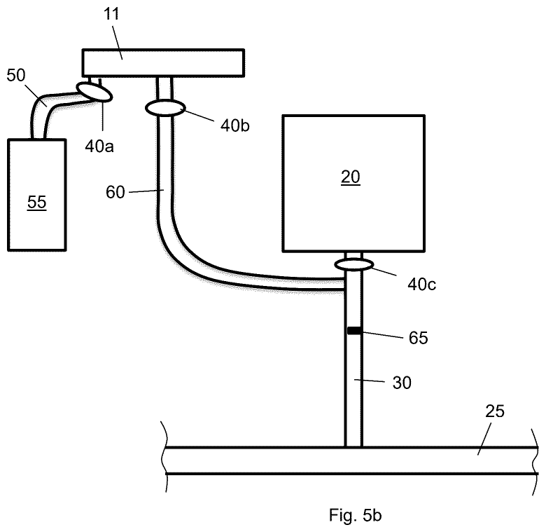

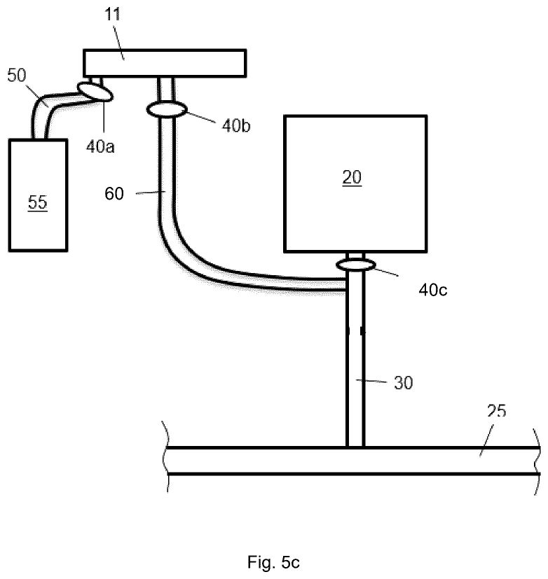

FIG. 5a illustrates one embodiment of clog 65 positioned within the drain line of a fixture (e.g., sink). Often, the clog is present within the drain line, between the fixture and sewer line 25, as shown. Conventionally, a plumber would be required to unclog the drain using a snake or other standard tools. However, when system 5 is incorporated into the plumbing assembly, the clog can be easily removed without requiring the inconvenience and expense of a visit from a plumber. As shown in FIG. 5b, dedicated outlet 60 is incorporated into drain line 30, along with a valve.

A user can remove the clog by opening valve 40a in hot water line 50, thereby allowing hot water to flow into manifold 11. The system valves can be independently and/or manually opened as desired by an operator in some embodiments. In other embodiments, a controller actuates the system valves and therefore the flow of water to the jets, allowing an operator to remote control the system without having to be physically present at the site of the clog.

Valve 40b associated with the outlet line in fluid connection with the vanity is then opened, allowing the hot water to flow from the manifold, through outlet line 60 only. The other outlet lines in the array remain closed off and no hot water flows through these outlets. Thus, the other outlet lines (e.g., to the toilet, bathtub, etc.) remain closed because the corresponding valves remain in a closed orientation. In this way, the hot water flows only to the vanity drain line (element 60 in FIG. 5b). The hot water then flows from the outlet line and into the vanity drain line, forcing water and debris from the clog down and through the drain line and into the sewer line. The remainder of the outlet lines remain closed, such that water only flows through the outlet line and drain line at the location of the clog.

In some embodiments, air chuck 45 can be used to increase the pressure within the outlet line and into the vanity drain line, thereby using pressure to more effectively dislodge the clog. Thus, the standard hot water pressure can initially dislodge the clog and gravity may force the debris down drain line 30. However, gravity is not always adequate to keep the drain line clog free and clear of debris. Therefore, the air chuck may activate and force pressurized water or air through the drain line and into the main wastewater drain line and/or sewer line 25.

By closing the valves as described above and opening the hot water to create a pathway to a clog, any clog in the plumbing array can be cleared. Valves on vents and the waste riser will prevent water to the floor above.

Once the clog is dislodged, valve 40a in the hot water line is closed, thereby stopping the flow of hot water into the system from the hot water source (e.g., a reservoir of hot water, such as a hot water heater). Valve 40b in the outlet line is also closed. Specifically, all of the valves 40 present within the outlet lines are closed until a clog forms and an unclogging action is needed. Valve 40c in the drain line is then activated from closed to open to allow for normal function of the fixture once the clog is cleared.

The system can be used as a maintenance feature. Specifically, the system can include a timer 47 that can be set for any desired time interval (e.g., daily, weekly, monthly) upon which the system runs as shown in FIG. 3d. The timer can be automated in some embodiments or manually set by a user. The frequency of the maintenance can depend on many factors, such as the number of times the system is used, how many users are present, etc. The timer can be configured as part of manifold 11, although the system is not limited, and any element can incorporate a timer. During maintenance, each drain line is flushed with hot water and/or air as described herein. All valves on the drain lines and vent lines associated with that manifold will activate from an open position to a closed position until every line has been individually flushed with hot water. One by one, each hot water valve will therefore activate from a closed position to an open position, thereby allowing the hot water to flush the drain line of an associated plumbing fixture. The active hot water valve then returns back to a closed position to allow the next hot water line to repeat the same process. The flushing will remove residue and leftover debris that can cause future clogs.

Once each waste line on that manifold has been flushed, all valves on the drain lines and the vent lines of a corresponding manifold that are in fluid communication activate and return the valves back to an open position to allow proper drainage and air flow. After the last hot water lines on the manifold have thoroughly flushed the waste line (e.g., with hot water or air) and the valves for each individual fixture return to a closed position, the valve that supplies the manifold with hot water closes to end the maintenance cycle. The process is repeated with the next successive manifold until all of the drain lines have been flushed on every manifold in a particular environment (e.g., dwelling). By providing the maintenance function, system 5 can prevent future damage that would inevitably result from clogs.

An automated system as described herein can include specific software that allows the system to act without user input. For example, if a clog or partial clog is detected (e.g., using a sensor), the system software then acts to clear the clog as described above (e.g., the drain lines and vent lines are closed, the valve that supplies the manifold is opened to supply hot water to the manifold, and the corresponding valve is opened for the hot water line to flow to a plumbing fixture drain line that is registering clog). A pressure switch (or any type of switch that can identify clog) may be positioned on a side of a valve that can be locked off. A pressure switch can be configured to activate when water rises and fills the drain line completely to its location as in a clogged drain. Increased pressure trips a sensor that sends a signal to a relay box to activate the valves to work in a specific order to clear a clog and then to also send secondary signals to a relay telling the relay that the clog is clear and activating the valves back to normal standing positions. In some embodiments, a signal is sent to activate an air chuck to add pressure to the hot water because the clog did not clear from the application of hot water pressure only. In either case, the clogged drain line is automatically flushed.

Advantageously, system 5 can be used to lock off any drain line to minimize further damage. For example, if the plumbing array includes a broken pipe, the broken pipe drain line only can be locked off, preventing additional water damage and also to allow repairs with peace of mind that no one can flush water in that line until the repair is finished and the plumber turns the valves back to an operating position.

The system can also be used to flush traps (e.g., grease traps, hair traps). The traps are normally cleared manually. However, the disclosed system can be used to flush the traps using a volume of hot water or air as described above. The traps can be flushed using an automated system in some embodiments (e.g., a sensor in the drain line detects an increased pressure). In some embodiments, the traps are flushed at a set frequency (e.g., nightly in a hair salon or restaurant).

In some embodiments, the disclosed system can be used to flush out an air conditioning trap (e.g., air conditioning condensate drain trap). Such traps are essential for maintaining the efficiency and safety of HVAC systems. The trap allows condensate to drain from HVAC equipment and simultaneously prevents air from entering or escaping from equipment. In use, the condensate trap prevents the HVAC unit from sucking air from (or blowing air into) the drain line. Please see, U.S. Pat. Nos. 8,961,708 and 9,657,964, incorporated by reference herein. The disclosed system can be installed in an HVAC line as noted above to flush the air trip with fluid and/or air as needed to prevent clogs.

Optionally, the system can include an ultrasound probe used to detect the volume of water, thereby indicating the presence or absence of a clog. The term “ultrasound” refers to an acoustic wave with frequencies greater than about 20 kilohertz. The ultrasonic wave can be transmitted by a probe. The probe can be implemented by preparing probes for sector scanning, linear scanning, convex scanning, and so on and selecting and using an appropriate one of them in accordance with the part to be imaged (e.g., the plumbing array lines). The probe can include a transducer array, two or more light emission units, and a housing in some embodiments. The transducer array is an acoustic wave detector. The two light emission units may be disposed on both sides of the transducer array with the transducer array interposed therebetween in such a manner that each of the light emission units is disposed on either side. The housing accommodates the transducer array and the light emission units.

The presently disclosed system includes many advantages. For example, the system can be easily retrofitted to existing plumbing systems. Alternatively, the systems can be effectively added to new plumbing systems (e.g., in new construction).

System 5 can be used in a variety of environments, such as retail, restaurant, industrial, commercial, and/or residential plumbing systems. Further, the system can be installed in floor drains that are commonly found in office buildings and storage facilities that can also be used as trap primer since they are necessary in floor drains.

System 5 allows an operator to remove a clog from a plumbing array manually, through an automated system, or remotely, thereby saving time and preventing the significant expense of using a plumber's services.

The disclosed system is easy to use, such that it requires little to no training for successful operation.

The disclosed system can quickly dislodge a clog from the drain line of an associated fixture drain line, allowing the plumbing system to be operational again.

The disclosed system can also be used to assess damage to the drain line of a fixture. For example, a specific drain line can be closed off using the disclosed outlet lines and valves. Air and/or water can then be used to pressurize one or more specific waste lines in conjunction with a pressure gauge on the manifold. Once a waste line is pressurized to a desired pressure, if a decrease in pressure is observed, an operator will know that damage to that specific waste line has occurred. Repairs can then be accomplished to mitigate the future problem before it happens. The system therefore provides an easy and streamlined approach to detecting leaks in the fixture drain lines of a plumbing array before they happen, thereby avoiding costly repairs due to the contained and systematic way of testing.

Thus, the disclosed system and method can be used to clear a clog or other obstruction from one or more drain lines of a plumbing array. The system includes a manifold comprising a hot water inlet line in fluid communication with a hot water source. A plurality of outlet lines are operatively connected to the manifold, each outlet line in fluid connection to a dedicated fixture in an environment. Each outlet line comprises a valve configured to open or close the flow of water through the outlet line. Each outlet line is coupled with a drain line of the dedicated fixture. Hot water from the hot water inlet line is configured to flow within the interior of the manifold and be selectively distributed to a desired outlet line. With this system, a user can utilize a multifaceted array such as unclogging a drain, maintaining a system with routine cleanings, testing to avoid bigger issues down the line, and even being able to be a trap primer.

In some embodiments, the system can be automated to allow a user to set it and forget it, saving money in overhead and insurance policies. There are so many functions this brings and above all the data collected to identify problem areas that keep clogging. The system therefore allows a user to fix issues that would not be tracked otherwise. This system can be useful in real estate to know what a buyer is getting with all data compiled from software. For instance, the system can collect pertinent data (e.g., frequency of clogs in a particular environment/line/fixture, severity of a clog, response time to clear the clog, dates/times of clog events, and the like). The data can be used to provide summary details for a particular environment, and may be useful in events such as the sale of an apartment building as an indication of future clogging issues.

As described above, although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A drain clog removal system, the system comprising:
a manifold comprising a hot water inlet line in fluid communication with a hot water source that is external to and forms no part of the drain clog removal system;
a plurality of outlet lines operatively connected to the manifold, each outlet line in fluid connection to a dedicated fixture that is external to and forms no part of the drain clog removal system, wherein each outlet line comprises a valve along a length of each outlet line configured to open or close flow of water through the outlet line;
wherein each outlet line is coupled with a drain line of the dedicated external fixture; and
wherein hot water from the hot water inlet line is configured to flow within the interior of the manifold and be selectively distributed to a desired outlet line.

2. The system of claim 1, wherein the manifold is in fluid communication with an air chuck.

3. The system of claim 1, wherein the hot water line includes a valve that controls the flow of hot water into the manifold.

4. The system of claim 1, wherein the valve is a solenoid valve.

5. The system of claim 1, wherein the external dedicated fixture is selected from at least one toilet, sink, bathtub, shower, washing machine, or combinations thereof.

6. The system of claim 1, wherein the valves are independently operated.

7. The system of claim 1, wherein the valves are remotely operated.

8. A method of removing a clog from a fixture drain line in a plurality of fixtures, the method comprising:
activating the valve of an outlet line of the system of claim 1 to an open position, allowing the flow of hot water from the manifold through the outlet line to the drain line of a fixture comprising a clog in the associated drain line;
whereby hot water travels from the hot water source, through the hot water line into the manifold, through the open valve to the outlet line and to the drain line of the fixture comprising a clog to dislodge the clog from the drain line.

9. The method of claim 8, wherein the plurality of fixtures are selected from one or more toilet, shower, sink, bathtub, or washing machine.

10. The method of claim 8, comprising activating a valve positioned on the hot water line to an open position, allowing the flow of hot water into the manifold prior to activating the valve of the outlet line.

11. The method of claim 8, wherein the valve of the outlet line in communication with the clogged drain line is activated to a closed position blocking the flow of hot water from the manifold through the outlet to the outlet line after the clog has been dislodged.

12. The method of claim 8, further comprising activating an air chuck in fluid communication with the manifold to supply a pressurized flow of hot water.

13. The method of claim 8, wherein the valves are solenoid valves.

14. The method of claim 8, wherein the valves are independently operated.

15. The method of claim 8, wherein the valves are remotely operated.

16. A waste line monitoring system comprising:
one or more sensors positioned relative to drainage infrastructure and configured to detect flow restriction conditions in drain lines, wherein the sensors comprise any type of switch that can identify clog conditions including full or partial blockage;
a processing unit comprising a relay box configured to receive sensor signals and specific software configured to process sensor signals to determine when maintenance actions are required;
an automated response system configured to initiate maintenance actions based on sensor signal processing, wherein the maintenance actions comprise at least one of automatic valve activation for cleaning, operator notification through remote communication, or drain line isolation;
wherein the sensors are configured for automated detection to identify developing clog conditions and the system operates through automated maintenance cycles to prevent drainage failures without user input.

17. A method of testing drainage infrastructure integrity comprising:
isolating individual drain lines using valves configured to open or close flow through outlet lines coupled with drain lines of dedicated fixtures;
applying air and/or water to pressurize one or more specific waste lines in conjunction with a pressure gauge on the manifold;
monitoring pressure variations wherein if a decrease in pressure is observed after pressurization to a desired pressure, an operator will know that damage to that specific waste line has occurred;
enabling repairs to mitigate future problems before they happen through systematic detection of waste line damage;
wherein the testing provides an easy and streamlined approach to detecting leaks in fixture drain lines without invasive access to drainage systems.

18. (canceled)
